(19) United States
(12) Patent Application Publication
(10) Pub. No.: US 2010/0170125 A1
(43) Pub. Date: Jul. 8, 2010

(54) Rigid Transparent Chart Holder

(76) Inventors: Gregory Scott Taylor, Beaver, OH (US); Michael James Freeman, Chillicothe, OH (US)

Correspondence Address: Michael Freeman, 800 Crouse Chapel Rd, Chillicothe, OH, 45601, US

(21) Appl. No.: 12/348,315

(22) Filed: Jan. 4, 2009

(51) Int. Cl. G09F 3/18

(52) U.S. Cl. 40/661

(57) ABSTRACT

A holder for charts having two transparent sheets, a connecting mechanical hinge and non-ferrous latching devices. The chart holder is sized to hold aeronautical charts and related flight planning documents. The hinge allows the two transparent sheets to be opened at least 180 degrees where the charts and documents can easily be place therein. The two sheets are able to close together, clamping the charts and documents between them. The two sheets are kept together by the latching devices. The transparent sheets provide an erasable writing surface where the pre-flight plans and in-flight data can be drawn and written with a non-permanent marker, thus protecting the documents enclosed. The chart holder also provides for the storage of the non-permanent marker. The chart holder can easily be opened with one hand to allow for repositioning of documents in flight. The transparent sheets have a tab allowing for an offset tab arrangement to allow for quick identification between multiple chart holders.

### CROSS-REFERENCE TO RELATED APPLICATIONS

This application claims the benefit of PPA Ser. No. 61/009,818.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to the organization and display of aeronautical charts and other pertinent documents during pre-flight planning and in-flight navigation.

2. Background of the Invention

Pilots must prepare a detailed pre-flight plan obtain all necessary information pertinent to the flight. Since pre-flight planning is essential to flight safety, it is advantageous to use any tools to aid in effective and accurate flight planning. During pre-flight planning, the appropriate aeronautical charts (Sectionals, WACS, IFR Enroute Charts, Approach Plates etc.) are laid out so that the course can be determined and the course line drawn on the appropriate charts. Other flight planning information, such as the current weather conditions, planned altitude, course heading, leg times, navigational aid and communication frequencies and airport information, is typically written on separate pieces of paper. All of this information has to be organized and arranged in a confining aircraft cockpit and able to be accessed with minimal distraction from flight operations. During the flight, the appropriate chart with the course line has to be visible to the pilot. The pilot marks the chart to indicate the flight progress. Many devices, too numerous to list, have been developed to improve the management of paper flight planning information utilizing clipboards, kneeboards and lap desks. This prior art has many disadvantages:
(a) The charts and supplemental documentation are hard to keep organized especially the charts not currently in use. Also multiple charts are difficult to distinguish from one another. When using a clipboard/kneeboard, charts are difficult to change or reposition.
(b) The course lines drawn on the charts have little contrast from the chart printing. After multiple uses, the chart becomes cluttered with multiple course lines or becomes unreadable due to erasure of previous course lines.
(c) Separate pieces of paper are used to take in-flight notes which increase the number of documents to manage and obscure the charts in use.
(d) Inadequate rigid surface provided for note taking during the flight.
(e) The charts are made of thin paper and are easily torn when handled. The charts tend to become worn out and useless prior to their expiration date.
(f) Cockpit air currents can cause the charts to flutter or become displaced.

U.S. Pat. No. 2,791,040 to Santororelli (1957), U.S. Pat. No. 4,641,440 to Agranov (1987) and U.S. Pat. No. 5,007,192 to Hochberg (1991) have solved many of these disadvantages. Each of these inventions has a transparent protective surface to protect the chart which allows writing on these protective surfaces without writing directly on the charts. The drawback to these devices is that they are single sided, thus requiring that the chart be rotated during flight. Several of these inventions in their preferred embodiment are quite large and would be difficult to use in the small confines of an aircraft cockpit.

Several two sided chart holders have been developed, for example U.S. Pat. No. 3,553,864 to Karlyn and Fedak (1971) and U.S. Pat. No. 5,647,156 to Hull and Burnett (1997). Although these devices have solved many of the aforementioned disadvantages, they both utilize an integral spring hinge. This design will reduce durability as the material along the hinge will crack after repeated cycling of the hinge. Also, with either design, inserting, removing and repositioning the charts and documents will require the use of both hands, which can prove awkward during flight.

For a number of reasons, the aforementioned chart holders have not gained widespread use. In general, these devices all have had short comings in either their functionality or their ease of use.

2. Objects and Advantages

Accordingly, several objects and advantages of the present invention are:
(a) to provide a chart holder that maintains the organization of the charts and documents;
(b) to provide a chart holder that provides for easier differentiation between multiple charts;
(c) to provide a chart holder that improves the handling of charts and documents;
(d) to provide a chart holder that protects the charts and documents from damage;
(e) to provide a chart holder that improves the visibility of the course lines and notes without defacing the charts;
(f) to provide a chart holder that provides ample rigid surface for writing, which is done directly on the surface of the chart holder using a non-permanent marker;
(g) to provide a chart holder that allows for viewing of both sides of the chart or document.
   Further objects and advantages are to provide a chart holder that is durable, inexpensive to manufacture, and is easy to use in the confines of an aircraft cockpit. The mechanical hinge of this invention enables the chart holder to open fully (minimum of 180 degrees) which allows for easy arrangement of the charts and documents within the chart holder. The mechanical hinge and hook and loop fasteners, of the preferred embodiment, also allows the chart holder to be opened and closed single handedly, in the event that the charts or documents need repositioned during flight. Still further objects and advantages will become apparent from a consideration of the ensuing description and drawings.

### SUMMARY

In accordance with the present invention the rigid transparent chart holder comprising of two side panels of rigid transparent material, a hinge to join the side panels and latching devices to keep the panels together. The chart or other document is placed between the transparent side panels, whereby revealing both sides the chart beneath the transparent side panels, which also act as writing surfaces using a non-permanent marker. This allows for course plotting and other in-flight notations without defacing the charts or documents.

### DRAWINGS—FIGURES

FIG. 1 shows the isometric view of the chart holder in the open position.

FIG. 2 shows the isometric view of the chart holder in the closed position.

FIG. 3 shows the isometric view of a stack of multiple chart holders illustrating offset tab arrangement.

### DRAWINGS—REFERENCE NUMERALS

10 transparent side panels

12 hinge

14 latching devices

16 offset tab

18 Non-permanent Marker

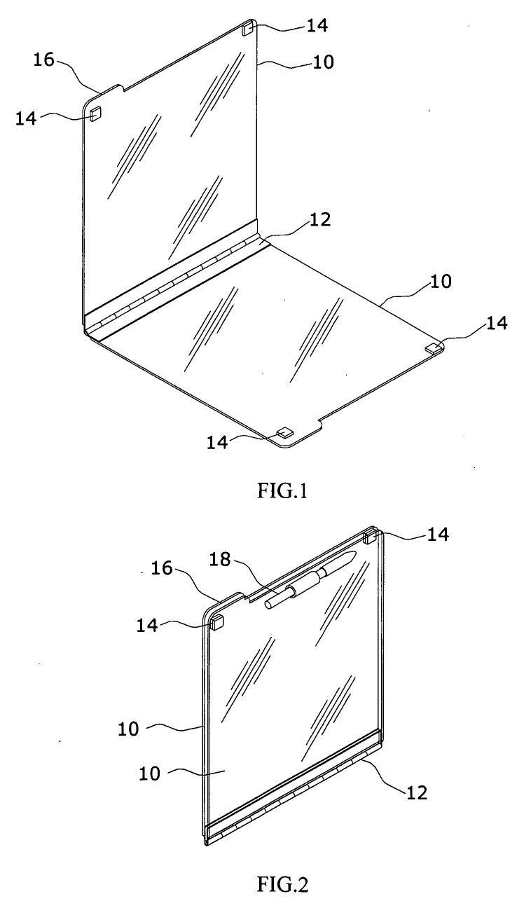

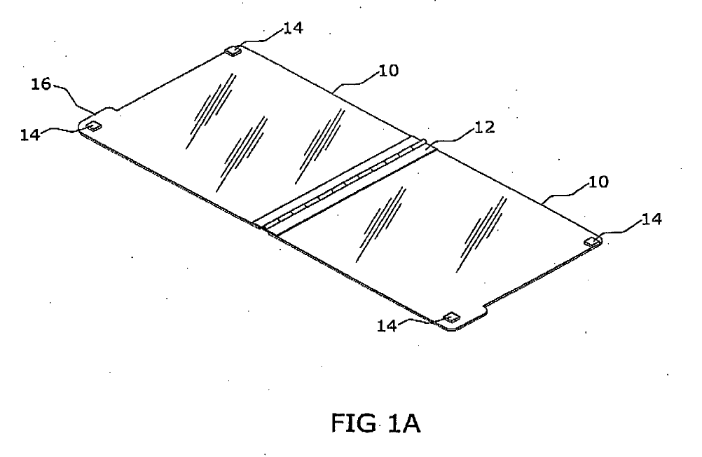

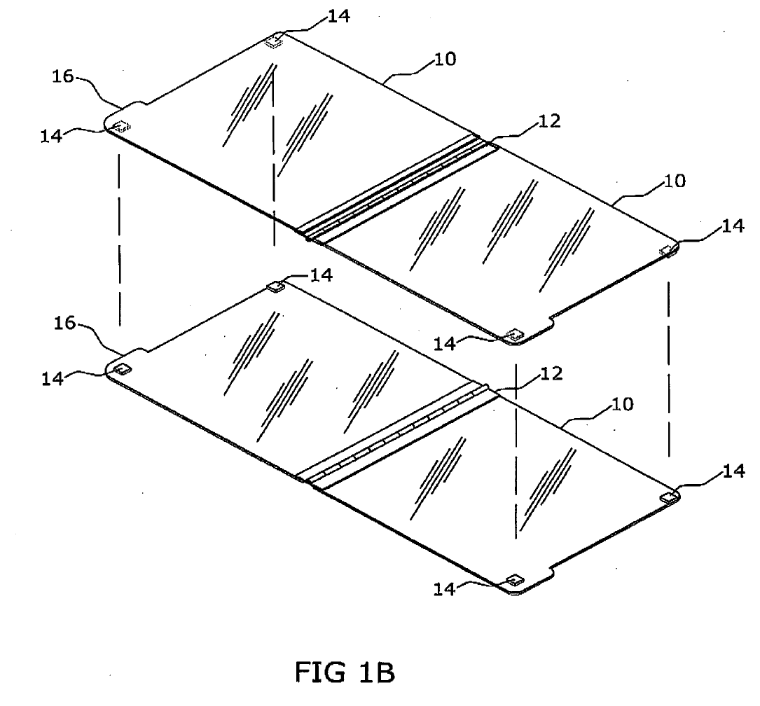

### DETAILED DESCRIPTION—FIGS. 1, 2 AND 3—PREFERRED EMBODIMENT

A preferred embodiment of the chart holder of the present invention is illustrated in FIG. 1 (open view) and FIG. 2 (closed view). In the preferred embodiment, the two side panels 10 are made of a rigid transparent plastic, such as Acrylic. The two side panels 10 are to be of a sufficient texture to permit the surface to be written upon with a non-permanent marker and easily wiped clean. In the preferred embodiment, the side panels are connected by a mechanical hinge 12, also of Acrylic or similar material. The mechanical hinge 12 allows the chart holder to be opened a minimum of 180 degrees.

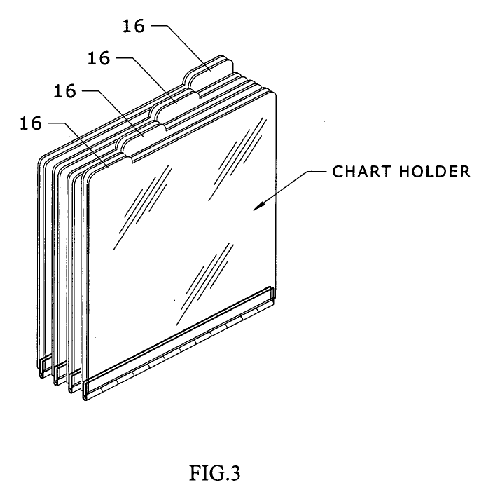

Mechanical latching devices 14, such as hook and loop, keep the chart holder in the closed position. Other suitable latching devices can be substituted. A means to removably attach a non-permanent marker 18, such as hook and loop, is also provided. As shown in FIG. 3, when using multiple chart holders, a system of offset tabs 16 located along the top edge of each holder is used for quick identification. Ferrous or magnetic materials are to be avoided in the construction of the chart holder due to the interference it may cause to the aircraft's magnetic compass.

### OPERATIONS—FIGS. 1, 2, 3

The manner of using the rigid transparent chart holder is to pull the side panels 10 apart, insert the desired charts or documents, arranging them to be viewed from either side. Next, bring the side panels 10 together until the latching devices 12 make contact keeping the side panels 10 securely together. The course line is then drawn on the surface of the side panels 10 that is overlaying the chart using a non-permanent marker. Other notes can be added as well, such as wind speed and direction, altitude, course bearing, runways of intended use, navigational aid and communication frequencies. Upon completion of the flight, the side panels 10 are pulled apart and the charts and documents removed. The side panels 10 are wiped clean to remove the course line and writing and are ready to be used again.

### Advantages

From the description above, a number of advantages of my rigid transparent chart holder become evident:
(a) The construction is simple and durable.
(b) The mechanical hinge allows for the chart holder to lay flat in the open position on a table or desk for easy arrangement of the charts and documents.
(c) The hook and loop fasteners keep the chart holder firmly closed and thus the charts and documents securely positioned, yet allows for the chart holder to be opened using a single hand.
(d) The surface of the side panels can be directly written upon with a non-permanent marker and easily wiped clean; the non-permanent marker is conveniently attached to the chart holder.
(e) An offset tab arrangement to allow for quick identification between multiple chart holders.

### Conclusion, Ramifications, and Scope

Accordingly, the reader will see that the rigid transparent chart holder will greatly enhance the organization of aeronautical charts within the aircraft cockpit. The chart holder protects the charts and documents and provides a much clearer viewing of the course line and notes. The rigidity of the chart holder provides an excellent platform for writing down in-flight notes. Since the chart holder utilized two transparent side panels, both sides of the charts can be viewed, thus the charts will not need refolded as often during flight.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by the example given.

We claim:

1-6. (canceled)

7. A rigid transparent chart holder for containing, organizing and protecting flat charts and documents during preflight planning and in the cockpit of an aircraft during flight operations, comprising of two side panels of rigid transparent material of sufficient size to accommodate one or more charts or documents within its dimensions, a transparent non-ferrous mechanical hinge to join the said panels of rigid transparent material and two latching devices mounted on the said panels to keep said panels together, securing the charts or documents contained within.

8. The rigid transparent chart holder of claim 1 wherein said panels have identifying offset tabs to allow for tactile distinction between multiple chart holders, this is an improvement of the known art of using tabs for visual identification and allows the selection of the desired chart without interrupting the pilot's visual scan, the tab of the first rigid transparent chart holder is located along the first quarter of the top edge and the tab of the second rigid transparent chart holder is located along the second quarter of the top edge and so on creating a set of four rigid transparent chart holders each with a uniquely positioned identifying tab.

9. The rigid transparent chart holder of claim 1 wherein the said transparent non-ferrous mechanical hinge allows the chart holder to be opened 180 degrees or greater, without a tendency to pull or spring closed, which allows for the insertion and removal of maps and the like using a single hand, allowing the pilot to keep contact with the flight controls, and will provide long life and the durability needed for the frequent cycling accumulated by the intended use of the rigid transparent chart holder

10. The rigid transparent chart holder of claim 1 wherein latching devices are mounted on the said panels to keep said panels together, securing the charts and the like, yet allow for easy separation, where the preferred embodiment utilizes two hook and loop fasteners, situation as such as not to be hindered by the position of the chart.
